(19) United States
(12) Patent Application Publication
(10) Pub. No.: US 2012/0115981 A1
(43) Pub. Date: May 10, 2012

(54) COMPOSITE BONE CEMENTS WITH A PMMA MATRIX, CONTAINING BIOACTIVE ANTIBACTERIAL GLASSES OR GLASSCERAMICS

(75) Inventors: Enrica Verne', Torino (IT); Marta Miola, La Cassa (Torino) (IT); Sara Ferraris, Grugliasco (Torino) (IT); Alessandro Masse, Torino (IT); Alessandro Bistolfi, Torino (IT); Maurizio Crova, Pecetto Torinese (Torino) (IT); Giovanni Maina, Baldissero Torinese (Torino) (IT)

(73) Assignees: UNIVERSITA' DEGLI STUDI DI TORINO, Torino (IT); POLITECNICO DI TORINO, Torino (IT)

(21) Appl. No.: 13/383,161

(22) PCT Filed: Jul. 12, 2010
(86) PCT No.: PCT/IB10/53181

§ 371 Date: Jan. 9, 2012

(30) Foreign Application Priority Data
Jul. 10, 2009 (IT) TO2009A000518

(51) Int. Cl. C08K 3/40; C08L 33/10

(52) U.S. Cl. 523/117; 523/116

(57) ABSTRACT

A bone cement comprising an acrylic polymeric component and an inorganic component comprising a bioactive glass or glass-ceramic, comprising at least one metal oxide having an anti-bacterial activity, wherein said glass or glass-ceramic component is adapted to release ions of said metal in contact with physiological fluids. The bone cement performs a sustained antibacterial action, also promoting binding with the tissues with which it is contacted, and it is advantageously employed in the fixation of orthopaedic prostheses, in the production of temporary prostheses and in spinal surgery.

The present invention relates to acrylic polymer-based bone cements capable of promoting osteointegration and simultaneously preventing the onset of post-operative infections.

In the clinical practice, cemented fixation of orthopaedic prostheses (hip, knee) implies the application of acrylic cements, typically comprising in situ-polymerised polymethylmethacrylates (PMMA).

PMMA cements are typically prepared from two components: a liquid and a powder. The liquid includes methylmethacrylate (MMA) monomers, an accelerator and/or inhibitor. The powder includes PMMA microspheres, a polymerisation initiator and/or radio-opacifying agent. These cements promote both the short-term and long-term prosthesis stability, through a mechanical anchorage, yet they do not become completely integrated with the bone tissue and exhibit poor mechanical properties. The PMMA-based cement is also used for making temporary prosthetic devices in case of revision.

A further use for this material is in spinal surgery in case of vertebral fractures, wherein PMMA is injected into the fractured vertebra for the consolidation thereof.

A significant problem in implant surgery is the possible development of infections. Indeed, the temporary prosthetic devices are often used during the infection treatment step by systemic or localised antibiotic administration.

In recent years, several expedients have been established in order to prevent the onset of periprosthetic infections; however, even though the infection rate has decreased, the problem is not completely solved. The possibility of introducing antibiotics directly into the bone cement used for fixing the prosthesis, so as to prevent the settlement of germs at the bone tissue-cement-prosthesis interface, has been known since the '70s. Since then, many investigations have been carried out to prove the effectiveness of such a method, by using different antibiotics and different bone cements.

Moreover, which way is the best way for introducing antibiotics into the cement is presently under discussion; in fact, the drug powder may be added manually during surgery to the polymer powder, or the blend may be accomplished directly during manufacture with industrial techniques.

In particular, the use of cements commercially-added with antibodies developed mainly in European countries; in contrast, in the United States it is preferred to introduce the required antibiotic manually during surgery.

In spite of the great numbers of data present in literature, very few studies actually compare commercially produced antibody-added cements and cements added in situ with antibodies. Even nowadays there is not a sufficient amount of extensive data that prove the effectiveness of cements added with antibiotics.

Also bio-active bone cements containing PMMA, a bio-active glass prepared from SiO₂—CaO—P₂O₅ and antibiotics, are known. Bio-active glasses described by L. L. Hench in Bioceramics, J. Am. Ceram. Soc. 81 [7] (1998), 1705-1728 are characterised by the fact that they are able to induce an actual chemical bond with bone tissue, thanks to their ability of interacting with biological fluids, thereby forming a hydroxyapatite layer on the surface thereof.

Even though on one hand the use thereof can improve the osteointegration characteristics, the problem remains of conferring adequate and long-lasting antibacterial properties to the bone cement.

In these cements, the antibody active principle normally is mixed with the polymer phase and constitutes a third phase in the cement composition.

Furthermore, the use of PMMA bone cements containing antibacterial metal salts has been proposed; WO82/01990 describes a bone cement for cementing prostheses, which contains polymethylmethacrylate, a load of glass fibre or quartz particles and a material designed to release silver ions in the form of a colloidal silver salt. In this case, too, we are dealing with a three-phase composition, in which it is difficult to regulate a sustained release of the antibacterial metal ions. Moreover, the glass phase is not bioactive.

One object of the present invention is to provide a novel bone cement composition, particularly for use in the fixation of orthopaedic prostheses, in spinal surgery or in the production of temporary prostheses, made of acrylic polymers, which at the same time is suitable to promote binding to the tissue with which it comes into contact, and thus integration of the prosthetic device, and suitable to effect a sustained antibacterial action.

For such a purpose, object of the invention is a bone cement having the characteristics defined in the claims that follow.

In the bone cement object of the invention, the acrylic polymer typically is polymethylmethacrylate (PMMA), but it may also be made of a methylmethacrylate and methylacrylate copolimer, or by a bisphenol-a-glycidylmethacrylate (bis-GMA) polymer or mixtures thereof.

The glass/glass-ceramic component is introduced in the form of a powder into the polymer component of the bone cement. The mixture thus obtained is subsequently polymerised in situ by stirring with the liquid monomer and the activator. Typically, according to the conventional technique, the polymer component and glass/glass-ceramic component mixture preferably contains a powdered X ray opacifier, for example zirconium dioxide and/or barium sulphate.

The liquid fraction contains the monomer, typically methylmethacrylate, in which a radical activator is dissolved such as for example N-N-dimethyl-p-toluidine. It is however understood that the invention is not restricted to the selection of specific initiators and/or radical activators.

The percentage of the glass/glass-ceramic component in the polymerised bone cement generally is lower than 80% by weight, referred to the total weight of the bone cement, and preferably is lower than 50% by weight, so as to allow for an excellent homogenisation with the acrylic polymer component. Percentages of the glass/glass-ceramic component from 10% to 50% by weight are preferred.

The granulometry of the glass powders, referred to as the largest granule size, typically is lower than 80 μm and preferably lower than 20 μm.

The bioactive glass/glass-ceramic component contains at least the following oxides: SiO₂, CaO, Na₂O, as well as at least one silver, zinc and/or copper oxide or mixtures thereof. Preferably, the glass/glass-ceramic component comprises:
SiO₂: 40-60% by moles;
CaO: 15-45% by moles;
Na₂O: 5-25% by moles;
Ag₂O: 0.1-10% by moles, preferably 0.1-1% by moles; and/or
ZnO: 0.1-20% by moles, preferably 0.1-10% by moles; and/or
CuO: 0.1-10% by moles; the total amount of antibacterial metal oxides preferably being not higher than 20% molar.

Further oxides may be added, such as P₂O₅, K₂O, MgO, Al₂O₃ e B₂O₃, individually or as mixtures of two or more of the mentioned oxides. By way of example, each of said oxides may be used in the glass composition in accordance with the following molar concentrations:
P₂O₅: 0-10% by moles, preferably 1-5% by moles;
K₂O: 0-10% by moles, preferably 1-10%;
MgO: 0-10% by moles, preferably 1-8%;
Al₂O₃: 0-3% by moles, preferably 1-3%;
B₂O₃: 0-3% by moles, preferably 1-3%;
CaF₂: 0-10% by moles, preferably 1-9%;

The glass/glass-ceramic component can be obtained by fusion of precursors of the above-mentioned oxides, typically carbonates. Alternatively, the glass/glass-ceramic component can be obtained by the sol-gel process.

The per se known sol-gel synthesis method is performed by stirring the metal alkoxides in solution, followed by hydrolysis, gelatinization and baking

The antibacterial element can be inserted into the composition in the form of an oxide during synthesis of the glass (or glass-ceramic) or preferably in an ion form, after synthesis, through ion exchange processes from solutions, for instance according to the method described in EP 1 819 372.

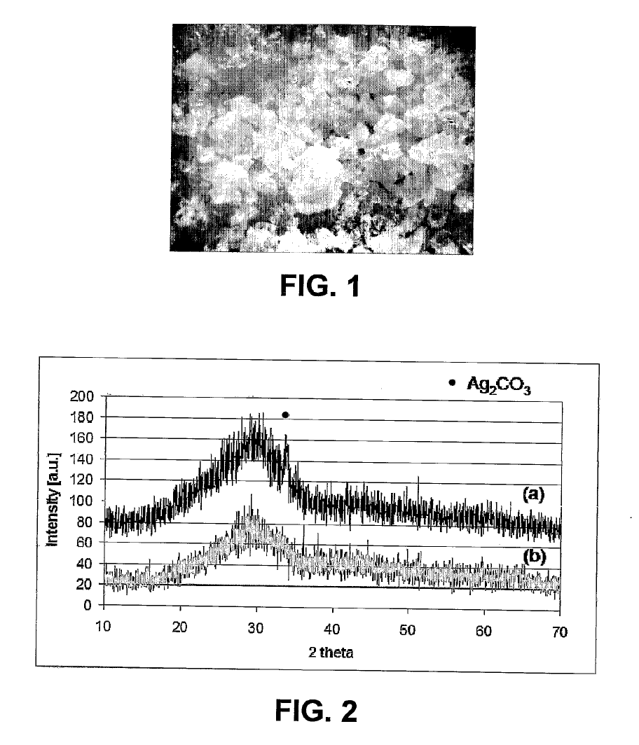

The ion exchange technique allows even high amounts of silver to be introduced into the glasses and glass-ceramics of suitable composition, which is difficult to achieve by the fusion and casting technique. Usually, the bio-glasses are synthesised by using refractory pots, therefore a high silver content may cause interactions between the silver and the pot, with formation of unwanted phases, and consequent non-uniform silver content in the different castings. Furthermore, the fusion and casting technique does not allow for an excellent silver dispersion and homogenisation within the material, with frequent formation of metal clusters (FIG. 1).

EP 1 819 372 describes the bulk application of the ion exchange method to glass and/or glass-ceramic materials or on metal coatings. For application on powders, the process parameters need to be suitably modified and controlled; in fact, the same conditions applied for instance to bulks and powders give decidedly different results.

Particularly the ion exchange technique on powders must be carefully examined for each specific glass/glass-ceramic composition employed, even considering parameters, such as for example the pH value of the exchange solutions, which generally do not have effect during the process performed on bulks, coatings and scaffolds.

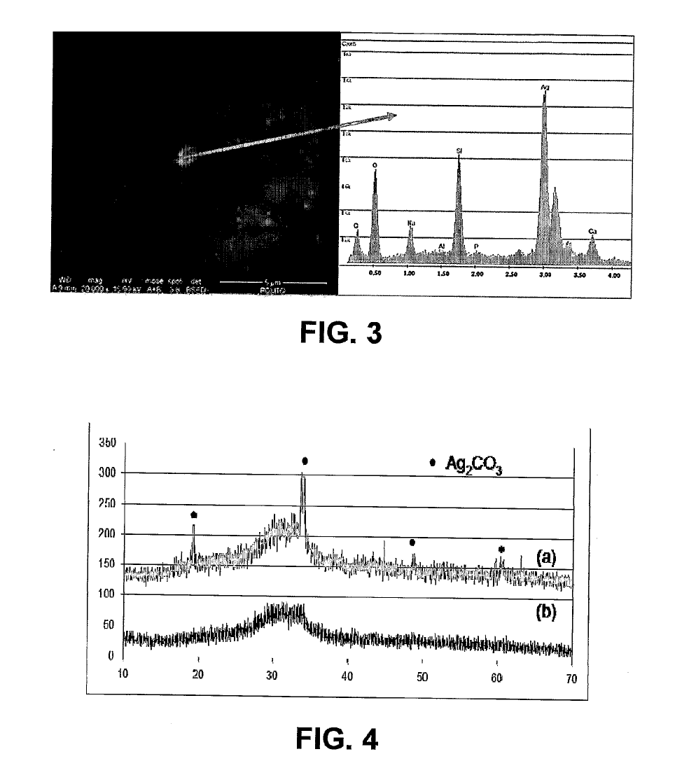

The high specific surface of powders makes them more reactive towards the surrounding environment and particularly during the ion exchange process in solution. For instance, glass powders (Example 1 composition), subjected to ion exchange under the same conditions of bulks and coatings with an identical composition, show precipitation of silver carbonate as a result of reaction between Ag+ ions and CO₂ or the carbonates in the reaction environment (FIG. 2.a, FIG. 3). The presence of silver carbonate precipitates on the bioactive glass powders, instead of ions diffused therein, does not ensure a gradual and sustained release of silver ions and establishes an uncontrollable phenomenon of a third phase formation. Powders with the same glass composition containing Ag or the other antibacterial ions previously mentioned, without precipitation of second phases, can be obtained only by carefully selecting the process parameters. (FIG. 2.b).

As previously anticipated, in order to obtain powders with an adequate dosage of silver ions without precipitation of other phases, not only the normal exchange parameters (time, temperature and concentration of the exchange solution) need to be varied and controlled, but also further parameters such as for example the pH of the exchange solutions.

In fact, precipitation of carbonates is favoured at highly basic pHs; instead, the maintenance of a pH between 5 and 8, preferably comprised between 7 (neutral) and 7.6, allows to favour maintenance of the antibacterial ions (e.g. silver) in solution, and thus a suitable diffusion thereof within the glass particles. Such a pH control could be carried out by adding a buffer to the exchange solutions; this solution however is not applicable to this specific case since it induces formation of other silver salt precipitates (chlorides, phosphates . . . ). In the application according to the invention it is preferable to use a glassy composition, the ion release of which does not make the solution highly basic (FIG. 4).

Thus, a relevant and preferred feature of the bone cements object of the invention is that the antibacterial agent is only incorporated in the glass or glass-ceramic material and additional phases other than glass or glass-ceramic made of or enclosing the antibacterial agent are absent, such as for example inter-metal phases or metal clusters or precipitates including the antibacterial agent.

Therefore, the bone cement composition according to the invention is essentially a monophasic composition with regard to the phases that include the antibacterial agent.

Such a feature allows to obtain a controlled release of the antibacterial ions when the bone cement is applied in situ in contact with physiological fluids.

To that end, it is thus preferable to prepare the bone cement by using glass or glass-ceramic material powder subjected to ion exchange in an aqueous solution containing antibacterial metal ions; the ion exchange process is carried out at temperatures below 100° C., preferably from 37 to 100° C., for periods of from 15 to 240 minutes, at a pH comprised between 5 and 8, by using a powdered glass or glass-ceramic material that includes metal ions (e.g. alkaline or alkaline earth materials) liable to exchange with the antibacterial ions (particularly silver).

In particular, a bioactive powdered glass or glass-ceramic material is used, the oxide composition of which is such that, when the material is kept in water, the release of chemical species from such a material is not capable of bringing the pH to values higher than 8, under balance conditions or for periods of up to 240 minutes.

Examples of compositions suitable for maintaining a neutral pH:

| | % wt | % mol | | % wt | % mol |
|---|---|---|---|---|---|
| SiO₂ | 49 | 49.81 | SiO₂ | 46.53 | 48 |
| Na₂O | 24 | 23.61 | Na₂O | 18.03 | 18 |
| CaO | 22 | 23.96 | CaO | 27.14 | 30 |
| P₂O₅ | 3.2 | 1.37 | P₂O₅ | 6.88 | 3 |
| B₂O₃ | 0.6 | 0.53 | B₂O₃ | 0.48 | 0.43 |
| Al₂O₃ | 1.2 | 0.72 | Al₂O₃ | 0.94 | 0.57 |
| TOT | 100 | 100.00 | TOT | 100.00 | 100 |

Further advantages and features of the bone cement according to the invention will be apparent from the following examples.

In the appended drawings:

FIG. 1 illustrates a glass frit containing 1% wt of Ag obtained by fusion and casting. The yellow colouring is likely due to the presence of nano-clusters.

FIG. 2 illustrates the X ray analysis of glass powders with a composition according to Example 1, exchanged under the same conditions as bulks and coatings (a) and under optimised ion exchange conditions (b).

FIG. 3 reports SEM and EDS analyses of precipitates containing silver on powders exchanged under the same conditions as bulks and coatings.

FIG. 4 illustrates an XRD analysis of glass powders that bring the pH of the exchange solutions at highly basic values (a) and of glassy powders (prepared according to Example 3) which instead favour the maintenance of a neutral or slightly basic pH (b) exchanged under the same conditions.

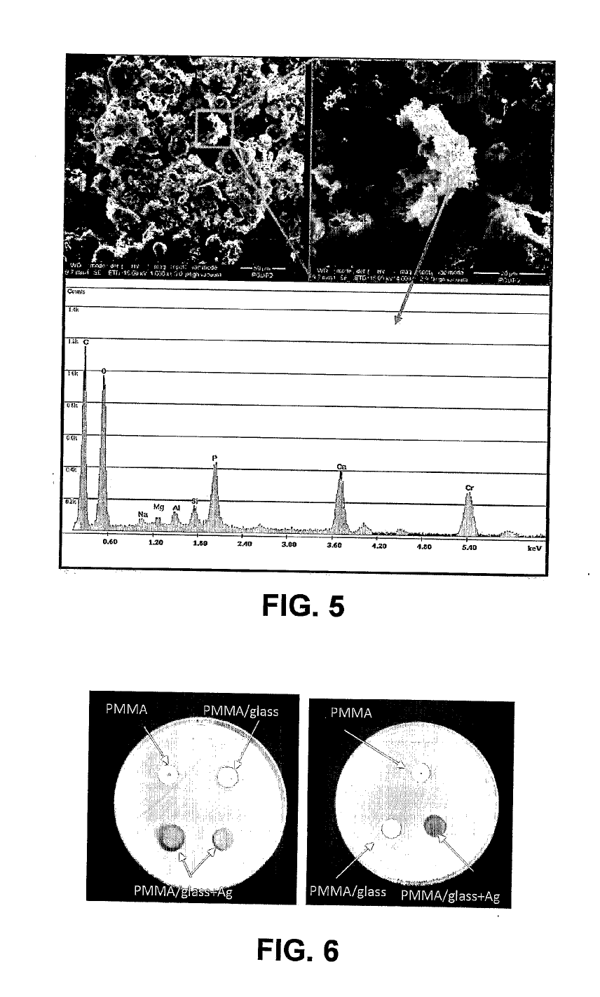

FIG. 5 illustrates SEM micrographs and an EDS analysis of a composite cement prepared according to Example 5b;

FIG. 6 illustrates the inhibition halo of composite cements prepared according to Example 4;

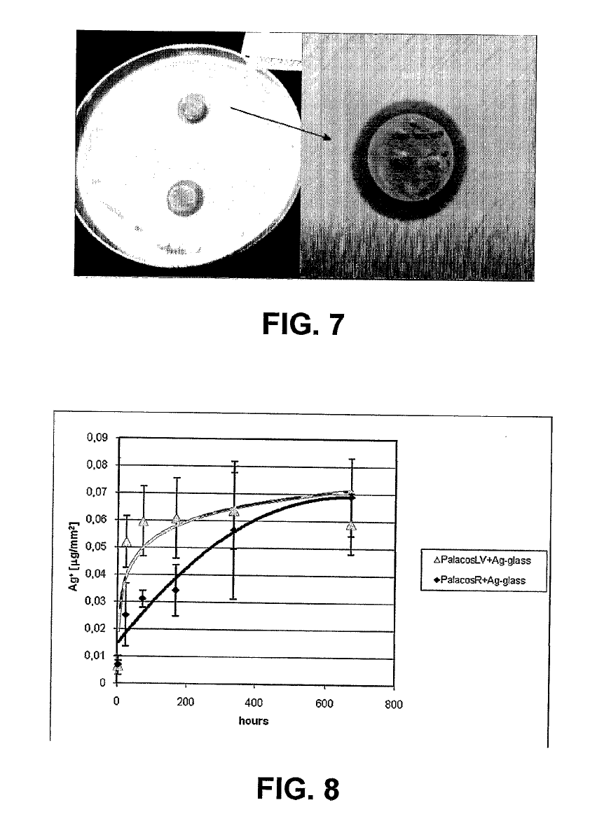

FIG. 7 illustrates the inhibition halo of composite cements prepared according to Example 5b;

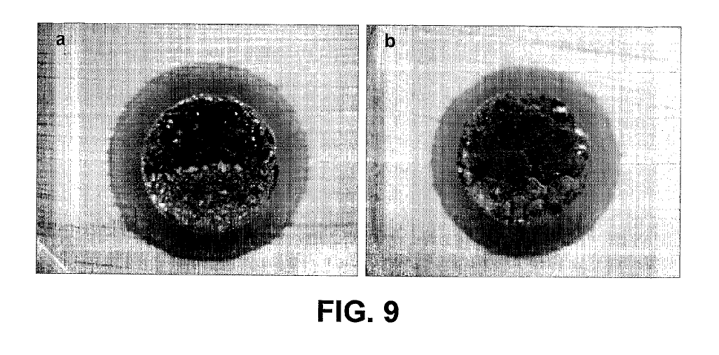

FIG. 8 is a diagram that illustrates the release trend of the silver ion from composite cements prepared according to Example 4.

FIG. 9 illustrates the inhibition halo of low-(a) and high-(b) viscosity composite cements prepared according to Example 6.

### EXAMPLE 1

### Preparation of the Bioactive Glass Component

A bioactive glass having the following composition was prepared:
SiO₂: 57% by moles
CaO: 34% by moles
Na₂O: 6% by moles
Al₂O₃: 3% by moles

The glass was prepared by using SiO₂, CaCO₃, Na₂CO₃, Al₂O₃ as the oxide precursors.

The fusion process was performed at a temperature of about 1400° C.-1550° C. and the molten was poured out into water to obtain powders.

The powder thus obtained was milled and sieved to a size smaller than 20 μm. The powders were added with silver ions by replacement of sodium ions through ion exchange in aqueous silver nitrate solutions, thereby obtaining a final glass composition of:
SiO₂: 57% by moles
CaO: 34% by moles
Na₂O: 5.9% by moles
Al₂O₃: 3% by moles
Ag₂O: 0.1% by moles

### EXAMPLE 2

### Preparation of the Bioactive Glass Component

The synthesis was carried out as in Example 1, by including though directly the silver oxide in the form of Ag₂CO₃ within the precursors, thereby obtaining a glass having the following molar composition:
SiO₂: 50% by moles
CaO: 24% by moles
Na₂O: 22.2% by moles
Al₂O₃: 0.7% by moles
P₂O₅: 1.4% by moles
B₂O₃: 1.4% by moles
Ag₂O: 0.3% by moles

### EXAMPLE 3

### Preparation of the Bioactive Glass Component

A bioactive glass having the following composition was prepared:
SiO₂: 48% by moles
CaO: 30% by moles
Na₂O: 18% by moles
P₂O₅: 3% by moles
Al₂O₃: 0.57% by moles
B₂O₃: 0.1% by moles

The glass was prepared as in Example 1 and silver ions were added by replacement of sodium ions through ion exchange in aqueous silver nitrate solutions, as in Example 1.

### EXAMPLE 4

### Preparation of the Cement

The powder obtained as in Example 1 was mixed with a polymeric polymethylmethacrylate component according to the following ratios:
PMMA: 50% by weight
glass components: 50% by weight

### EXAMPLE 5

### Preparation of the Cement

The powder obtained as in Example 2 was mixed with a polymeric polymethylmethacrylate component according to the following ratios:

EXAMPLE 5a
PMMA: 70% by weight
glass components: 30% by weight

### EXAMPLE 5b

PMMA: 50% by weight
glass components: 50% by weight

The tests performed demonstrated that the bioactive glasses/glass-ceramics, even when included in the polymeric acrylic composition, are capable of promoting the formation of a hydroxyapatite layer on their surface subsequent to reaction with mock physiological fluids.

### EXAMPLE 6

### Preparation of the Cement

The powder obtained as in Example 3 was mixed with a polymeric polymethylmethacrylate component according to the following ratios:
PMMA: 70% by weight
glass components: 30% by weight A micrograph of the surface of a composite cement prepared according to Example 5b is reported by way of example, where formation of hydroxyapatite is observed after immersion in a mock physiological solution for 28 days (FIG. 5).

The presence of a bioactive phase that becomes exposed on the cement surface causes this structure to promote the binding in vivo to the tissue with which it comes into contact, and thus integration of the prosthesis thus cemented. The presence of the glass/glass-ceramic component also has the advantage of decreasing the local temperature rise due to the exothermic character of the polymerisation reaction, with undisputed advantages for the bone directly in contact with the cement.

Moreover, adding the second glass/glass-ceramic phase does not alter the material's processing and hardening properties

In addition, the presence of the inorganic phase in the bone cement contributes to enhancing the cement's mechanical properties.

By suitably varying the glass composition and the parameters for the introduction of the antibacterial oxide, it is possible to modulate the bioactivity degree of the cement, the release kinetics of the metal ions and the mechanical properties of the composite material, depending on the particular application requirements.

The antibacterial tests on the bone cement were carried out by using each of the cement types mentioned in Examples 4, 5, 6.

The antibacterial effect of the composite cements was assessed by the inhibition halo test according to the NCCLS (National Committee for Clinical Laboratory) standards. Such a trial contemplates preparing a solution of known bacterial concentration and diffusing an aliquot of such a solution onto Mueller Hinton plates, which allow the bacteria to grow rapidly. The samples are placed on the plates containing the bacteria and incubated at 35° C. for 24 hours. At the end of the incubation the area where the bacteria did not grow is examined and measured.

The antibacterial tests were carried out by using a standard Staphylococcus Aureus strain, one of the bacterial strains most involved in the development of infections.

FIG. 6 shows a comparison between a bone cement manufactured according to Example 4 and a cement loaded with powders from the same bioactive glass without silver oxide.

FIG. 7 illustrates the antibacterial effect obtained with the cements described in Example 5b. FIG. 8 shows the antimicrobial capacity of cements described in Example 6 containing the glass dosed with silver through ion exchange with optimised parameters (Example 3).

The test results further demonstrate that the bone cement according to the invention allows to obtain a sustained release of antibacterial metal ions with an activity that lasts for periods of from about 7 days to more than a month and therefore results advantageous compared to the restricted antibacterial activity periods of bone cements loaded with antibiotics.

1-16. (canceled)

17. A bone cement comprising an acrylic polymeric component and an inorganic component comprising a bioactive glass or glass-ceramic, characterised in that the inorganic component comprises at least one metal oxide having an anti-bacterial activity, wherein said glass or glass-ceramic is adapted to release ions of said metal in contact with physiological fluids and wherein said antibacterial ion is incorporated in the glass or glass-ceramic component, additional phases other than glass or glass-ceramic including said ion being absent.

18. A bone cement according to claim 17, comprising:
from 10% to 80% by wt. of the glass or glass-ceramic component and
from 20% to 90% by wt. of acrylic polymeric component, referred to the total weight of said components.

19. A bone cement according to claim 17, wherein the glass or glass-ceramic component comprises:
SiO₂: from 40% to 60% by moles;
CaO: from 15% to 45% by moles;
Na₂O: from 5% to 25% by moles;
and at least one oxide selected from silver oxides, zinc oxide and copper oxide and mixtures thereof.

20. A bone cement according to claim 19, comprising one or more of the following oxides:
Ag₂O: from 0.1% to 10% by moles, preferably from 0.1% to 1% by moles;
ZnO: from 0.1% to 20% by moles, preferably from 0.1% to 10% moles;
CuO: from 0.1% to 10% by moles, preferably from 0.1% to 1% by moles; or mixtures of said oxides, the amount of anti-bacterial metal oxides being not higher than 20% by moles.

21. A bone cement according to claim 19, further comprising one or more of the following compounds or mixtures thereof:
P₂O₅: from 0% to 10% by moles, preferably from 1% to 5%;
K₂O: 0-10% by moles, preferably from 1% to 10%;
MgO: 0-10% by moles, preferably from 1% to 8%;
Al₂O₃: 0-3% by moles, preferably from 1% to 3%;
B₂O₃: 0-3% by moles, preferably from 1% to 3%;
CaF₂: 0-10% by moles, preferably from 1% to 9%.

22. A bone cement according to claim 17, wherein the polymeric component comprises polymethylmethacrylate and/or methylmethacrylate and methylacrylate copolymers or a polymer of bisphenol-alpha-glycidylmethacrylate.

23. A composition for the production of a bone cement comprising:
a powder phase including an acrylic polymer component and a glass or glassceramic component, which encloses an antibacterial metal ion, according to claim 17 and optionally including a polymerisation initiator and/or a radio-opacifying agent; and,
a liquid phase including an acrylic monomer and optionally a polymerisation accelerator and/or inhibitor, and wherein the antibacterial metal ion is only enclosed within the glass or glass-ceramic component, any additional phase including said ion being absent.

24. A composition according to claim 23, wherein said powder phase comprises:
from 10% to 80% by wt. of glass or glass-ceramic component; and
from 20% to 90% by wt. of acrylic polymeric component, referred to the total weight of said components.

25. A composition according to claim 24, wherein said glass or glass-ceramic component comprises from 10% to 50% by wt. referred to the total weight of said powder phase.

26. A bone cement according to claim 17, or a composition for the manufacture of a bone cement according to claim 23, wherein said bioactive glass or glass-ceramic component is obtained by an ion exchange process in an aqueous solution containing antibacterial metal ions, applied to a glass or glass-ceramic component powder under pH conditions kept between 5 and 8.

27. A bone cement or a composition for the manufacture of a bone cement, according to claim 26, wherein said glass or glass-ceramic component exhibits an oxide composition such that when kept in water, the release of chemical species from such a component is not capable of bringing the pH to values higher than 8, under balance conditions or for periods of less than 240 minutes.

28. A method for the manufacture of a bone cement according to claim 17, comprising mixing at least one acrylic polymer component and one powdered bioactive glass or glassceramic component enclosing an antibacterial metal, characterised in that said glass or glass-ceramic component is obtained by an ion exchange process in an aqueous solution including one or more ions of an antibacterial material, applied to a powder of said component, under pH conditions kept between 5 and 8.

29. The method according to claim 28, wherein said glass or glass-ceramic component exhibits a metal oxide composition such that when kept in water, the release of chemical species from said component is not capable of bringing the pH to values higher than 8, under balance conditions for periods of less than 240 minutes.

30. A method for fixation of orthopaedic prostheses comprising applying to said prostheses a bone cement or a composition for the manufacture of a bone cement according to claim 17.

31. A method for spinal surgery comprising applying a bone cement according to claim 17, as a reinforcement cementing material.
